(19) United States
(12) Patent Application Publication
(10) Pub. No.: US 2009/0112519 A1
(43) Pub. Date: Apr. 30, 2009

(54) Foreign object/domestic object damage assessment

(75) Inventors: Ari Novis, Rocky Hill, CT (US); Alexander I. Khibnik, Glastonbury, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/981,426

(22) Filed: Oct. 31, 2007

(51) Int. Cl. G06F 15/00

(52) U.S. Cl. 702/183

(57) ABSTRACT

A foreign-object/domestic-object damage assessment system for a gas turbine engine comprises a multiplicity of sensors, manifold feature extraction modules, a multiform analysis module, a hybrid operational data store and an operator/maintenance interface. The sensors characterize a multiplicity of engine parameters relating to the gas turbine engine. The feature extraction modules extract manifold features from the multiplicity of engine parameters. The analysis module performs a multiform analysis on the manifold features. The operational data store correlates the manifold features with maintenance actions via a hybrid engine model. The operator/maintenance interface transmits maintenance requests as a function of the multiform analysis, as compared to the hybrid engine model.

### STATEMENT OF GOVERNMENT INTEREST

This invention was made with Government support under contract number N00019-02-C-3003, awarded by the United States Navy. The Government has certain rights in this invention.

### BACKGROUND

This invention relates to gas turbine engines, particularly axial-flow gas turbine engines for aviation, industry, and related applications. More specifically, the invention is directed to foreign object damage (FOD) and domestic object damage (DOD) assessment, as applied to the operation of such engines.

Axial-flow gas turbine engines are typically constructed around a central core comprising a compressor, a combustor and a turbine in flow series with an upstream air inlet and a downstream exhaust nozzle. The compressor provides compressed air to the combustor, which mixes the air with a fuel and ignites it to produce hot combustion gases. The hot combustion gases drive the turbine, which in turn drives the compressor via a common shaft. Energy may be extracted in the form of rotational energy from the shaft, reactive thrust from the exhaust, or both.

The combustion and turbine sections are often arranged in a number of co-rotating or differentially-rotating, coaxially-nested spools. In a two-spool configuration, for example, the compressor and turbine are each divided into low-pressure and high-pressure spools or sections. The low-pressure turbine drives the low-pressure compressor via a low-spool shaft, and the high-pressure turbine drives the high-pressure compressor via a high-spool shaft.

Each spool of the compressor or turbine is further divided into a number of stages, in which rotating blades (rotor blades) alternate with stationary vanes (stator vanes). The vanes and blades typically have an airfoil cross section. This facilitates compression of incoming air in the compressor, and extraction of energy from expanding combustion gases in the turbine.

Aviation applications usually employ turbofan engines, in which a fan is deployed upstream of the compressor. The fan comprises one or more rotating airfoil blade stages, usually driven by the low-spool shaft, and may or may not include stator stages. Airflow from the fan divides into a core flow, which flows to the compressor and the rest of the engine core, and a bypass flow, which flows through a bypass duct surrounding the engine core. In some applications the fan is a compressor/fan, which replaces the low-pressure compressor.

Because the mechanical action of a gas turbine engine is substantially rotational, the technology has inherent performance and reliability advantages over reciprocating piston designs. The gas turbine engine is a complex system, however, in which a large number of close-tolerance mechanical elements are subjected to a high-pressure, high-temperature, and high-velocity flow of working fluid. This makes gas turbine engines susceptible to a number of operational risks, among which FOD and DOD events are potentially the most serious.

When an object enters the gas flow path of a turbine engine, there is a high probability that it will impact rotating or stationary components before being exhausted. This is true both for foreign objects ingested at the intake (FOD events), and domestic objects such as nuts, bolts or pieces of an airfoil liberated within the engine itself (DOD events). The risks of FOD and DOD events are increased, moreover, by the constant tradeoffs required by the competing demands of weight, performance, and structural durability.

While there is always a chance that a large-scale FOD or DOD event will cascade, resulting in severe engine damage, modern gas turbines are designed to make such events rare. Because of the extreme operating conditions, however, even initially minor FOD or DOD events can pose longer-term risks. In particular, relatively small nicks or cracks can impair cooling efficiency and structural integrity, resulting in a damage condition that propagates over time. Unchecked, damage propagation can convert a relatively minor FOD event into a relatively major DOD event, such as a partial blade liberation.

Periodic inspections and scheduled replacements for lifetime-limited parts can partially address this problem, but these methods are not directly sensitive to actual FOD and DOD events, nor to damage propagation in real time. More advanced diagnostic systems employ inlet and exhaust debris sensors, and also monitor trends in engine parameters such as blade passing time and shaft vibrations. These techniques can flag some FOD/DOD events as they occur, and can identify certain forms of damage propagation. Nonetheless there remains a difficult question of balance between the high cost of maintenance, when a non-FOD/DOD event is flagged, and the risk of engine failure, when a real FOD/DOD event is missed.

Specifically, indirect FOD/DOD indicators such as trends in blade parameters can be very subtle, particularly during the critical early stages of damage propagation. This makes it difficult to discriminate between actual FOD/DOD events and normal wear and tear based upon trending alone. Direct indicators are typically more obvious, but do not always distinguish between damaging and non-damaging events. Systems that rely only on debris sensors, for example, necessarily generate a number of false alarms (inspections that turn out to be unnecessary), because of confusion between high-risk ingestions (e.g., metallic runway debris), and low-risk ingestions (insects or leaves), which can produce similar signals. There is thus a constant need for more effective risk mitigation, and a lower false alarm rate. In particular, there is a need for a more generalized FOD/DOD assessment system that goes beyond direct indicators and trending to facilitate a more cost-effective gas turbine engine maintenance program, with reduced operational overhead and higher engine reliability.

### SUMMARY

A foreign-object/domestic-object damage (FOD/DOD) assessment system for a gas turbine engine utilizes a multiplicity of sensors to characterize engine parameters describing the function and operation of a gas turbine engine. Manifold feature extraction modules extract primary, secondary, and higher-order features from the sensors.

Primary features typically represent the engine parameters, as characterized by calibrated sensor signals. Primary features include a number of direct FOD/DOD indicators, including inlet and exhaust debris features, and blade passing time features.

Secondary features comprise derived features and trends. Derived features relate a number of different parameters to represent airspeed, altitude, Mach number or other complex physical parameters. Trends represent changes in engine parameters, such as an altitude trend that represents a rate of climb or descent. Secondary features also include a number of indirect FOD/DOD indicators, such as trends in a blade passing time or related blade feature.

Tertiary, quaternary, and other higher-order features encompass more generalized relationships than primary and secondary features. This includes higher-order FOD/DOD assessment features, which incorporate both physical and empirical relationships to more accurately direct maintenance requests to particular components of the gas turbine engine.

A multiform analysis module performs a multiform analysis on the manifold features. First, the multiform analysis module normalizes the features by scaling them to a set of standardized operating conditions such as airspeed and altitude, so that the features correspond to a set of (normalized) operational features stored in an operational data store (ODS). The ODS employs a hybrid engine model to associate the operational features with specific maintenance actions and corresponding engine conditions, which have been uploaded to the ODS via a maintenance log or maintenance record. The multiform analysis module then generates maintenance requests by comparing the normalized features to the operational features stored in the ODS, and determining a confidence level for the request based on the hybrid ODS model.

The operator/maintenance (O/M) interface comprises an operator interface and a maintenance interface. In various embodiments, the operator interface comprises a cockpit display and flight navigation system, a power plant control room console, or another form of gas turbine engine operator interface. The maintenance interface comprises the maintenance log or maintenance record, and is accessible both in real time and during periodic maintenance procedures.

A method for FOD/DOD assessment comprises sensing a multiplicity of engine parameters associated with a gas turbine engine, extracting manifold features from the engine parameters, performing a multiform analysis on the manifold features, and generating a maintenance request. The maintenance request is generated as a function of the multiform analysis, by comparing to an operational data store (ODS) and determining a confidence level for specific maintenance actions according to a hybrid ODS model.

### BRIEF DESCRIPTION OF THE DRAWINGS

FIG. 1 is a block diagram illustrating an FOD/DOD assessment system, utilizing manifold feature extraction and multiform analysis.

FIG. 2 is a schematic cross-sectional view of the FOD/DOD assessment system in FIG. 1, configured for operation with a gas turbine engine.

FIG. 3 is a flowchart illustrating a method for FOD/DOD assessment, utilizing manifold feature extraction and multiform analysis.

### DETAILED DESCRIPTION

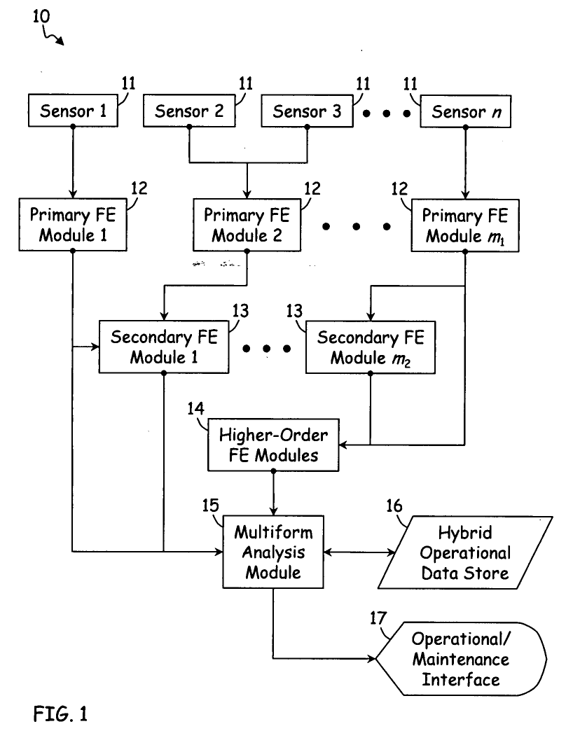

FIG. 1 is a block diagram illustrating FOD/DOD assessment system 10. System 10 comprises multiplicity of sensors 11, manifold feature extraction modules 12, 13 and 14, multiform analysis (MA) module 15, operational data store (ODS) 16 and operator/maintenance (O/M) interface 17.

Multiplicity of sensors 11 comprises a variety of different sensor types. Each sensor type comprises from one to a plurality of individual sensor devices. The individual sensor devices include, but are not limited to, pressure sensors, temperature sensors, flow sensors, uniaxial and multi-axial accelerometers, electromagnetic/eddy current and other blade sensors, lubrication system sensors, and electrostatic inlet and exhaust debris sensors.

The total number of individual sensors (n) is arbitrary, and configurable to meet the requirements of different gas turbine engine applications. The sensors are usually distributed in a number of different sensor groups, each corresponding to a sensor type or to a number of related sensor types. Some sensor groups comprise one or a few individual sensor devices, positioned in single-point or multiple-point configurations without any particular geometrical relationship. Other sensor groups comprise a number of individual sensor devices, positioned in axial, radial, circumferential or other configurations, which depend upon the specific function of the sensor group and the specific geometry of the components to which the sensor group is mounted.

Sensors 11 provide sensor signals that characterize a range of physical parameters, or engine parameters. The engine parameters include both operational parameters, which characterize the operating conditions of the gas turbine engine, and functional parameters, which characterize its real-time function and condition.

Some sensors 11 are discrete sensor devices such as thermocouples, which characterize a single engine parameter such as a temperature. Other sensors 11 are compound sensor devices such as differential pressure sensors, which characterize an engine parameter such as a flow rate using a number of individual sensor devices. Further sensors 11 are complex sensor devices such as blade sensors, which characterize a number of related engine parameters such as blade spacing, blade clearance and blade passing time.

In some embodiments, sensors 11 comprise a preamplifier, digitizer, or signal conditioning unit (SCU) to excite the sensor and produce analog or digital sensor signals characterizing the engine parameter. These sensor signals encompass a range of discrete, continuous scalar, vector, and other, more generalized signal functions. In other embodiments, sensors 11 produce unamplified analog sensor signals. In these embodiments, primary feature extraction (PFE) modules 12 comprise electronic components to perform the preamplification, digitization, or other signal conditioning functions. FIG. 1 is illustrative of functional, rather than physical or hardware distinctions, and does not distinguish between these embodiments.

Primary feature extraction (PFE) modules 12 comprise microprocessor components to process sensor signals, and to extract primary features from the processed sensor signals. Typically, the signal processing function is calibrated, such that the primary feature accurately represents the engine parameter in units appropriate for further analysis. In preferred embodiments, the processing function also compensates for temperature and other ambient variables, which affect the relationship between the sensor signal and the engine parameter (or parameters) that it characterizes.

Secondary feature extraction (SFE) modules 13 comprise microprocessor components to extract secondary (second-order) features from primary (first-order) features, or from other secondary features. Similarly, higher-order feature extraction (HOFE) modules 14 comprise microprocessor components to extract tertiary features from primary and secondary features (that is, from lower-order features), and from other higher-order features.

In preferred embodiments, system 10 also utilizes integrated sensor/feature extraction modules that combine the functions of sensors 11 and feature extraction modules 12, 13 and 14. In aviation applications, for example, system 10 typically comprises an air data computer that extracts a number of features of varying order (such as airspeed, calibrated airspeed, Mach number, altitude, and altitude trend) from a single Pitot-static sensor system. System 10 also encompasses “soft sensors” or virtual sensors. Virtual sensors extract features that are not directly measured by any particular sensor 11, but are instead calculated from other sensor signals. One example is a turbine inlet temperature, which is typically too hot for a standard temperature sensor but can be calculated from other sensor signals based upon well-known thermodynamic relationships.

Again, FIG. 1 is illustrative of functional, rather than physical distinctions, and does not distinguish among these various embodiments. These examples further illustrate that the definition of primary, secondary, and higher-order features typically varies from embodiment to embodiment, and, in come cases, from application to application within a specific embodiment. Many features, moreover, are repeatedly analyzed, and so play a number of different roles corresponding to a number of different feature orders. This is particularly true for direct FOD/DOD indicators such as debris features, and for indirect indicators such as trends in blade features. In the generalized approach of system 10, however, even operational features such as airspeed and altitude are involved in a wide range of analysis levels. Thus the precise configuration of system 10 varies from embodiment to embodiment, not only with respect to sensors 11 but also with respect to PFE, SFE and HOFE modules 12, 13 and 14.

System 10 is also configurable based upon past operational history. Specifically, system 10 is designed to continually incorporate new FOD/DOD assessment features that have been positively validated by high confidence level correlations between particular FOD/DOD indicators, as represented by the multiform feature structure, and actual physical damage to specific engine components, as characterized by the maintenance record uploaded to operational data store (ODS) 16.

Multiform analysis (MA) module 15 comprises microprocessor components to determine these correlations, by performing a multiform analysis on the manifold features extracted by PFE, SFE and HOFE modules 12, 13, and 14. First, MA module 15 scales the features as a function of the operational parameters, producing a set of standardized or normalized features. Next, the MA module compares the normalized features to a corresponding set of operational features stored in ODS 16, which represent the engine's operational history.

MA module 15 then generates maintenance requests as a function of the comparison, by using the hybrid ODS model to associate the normalized features with actual maintenance actions. When a maintenance request is positively validated by revealing actual FOD/DOD-related damage, system 10 typically creates a new FOD/DOD assessment feature to represent the correlation. MA module 15 also generates status reports for operator/maintenance (O/M) interface 17, and continuously uploads normalized features to ODS 16, in order to build the operational history.

Operational data store (ODS) 16 comprises memory components to store and access the operational history. The operational history comprises a set of operational features and associated maintenance features. The operational features are uploaded to ODS 16 by MA module 15, as described immediately above. The maintenance features are uploaded from a maintenance record or maintenance log via O/M interface 17. The maintenance features represent actual maintenance actions performed on the gas turbine engine (or other engines in the same class, as described below), and the corresponding physical condition of any engine components impacted by the maintenance actions.

Maintenance actions include, but are not limited to, visual inspection, borescope inspection, water wash, re-rigging of moving vanes, tear-down for ultraviolet inspection, periodic replacement of damaged or lifetime-limited components, and partial or complete engine overhaul. Physical conditions range from full functionality to complete component failure, and span a range of intermediate degrees of impaired functionality.

The operational and maintenance features stored in ODS 16 provide a detailed operational history of the gas turbine engine to which system 10 is directed. In preferred embodiments, ODS 16 also incorporates operational features and maintenance actions obtained during calibration tests performed before engine certification, or during periodic maintenance. In further preferred embodiments, ODS 16 incorporates additional operational and maintenance features representative of the entire engine class to which the gas turbine engine belongs. In these embodiments, ODS 16 provides access to a wide range of operational excursions and associated maintenance actions, which no one single engine would typically experience.

Operational data store (ODS) 16 associates the operational features with maintenance features via a hybrid engine model (a hybrid ODS model), which employs both physical and empirical correlations as described below. The maintenance features represent actual maintenance actions, and the corresponding physical condition of specific engine components impacted by the maintenance actions.

This allows MA module 15 to generate maintenance requests by comparing the normalized features (representing real-time engine function) to operational features (representing engine history) in ODS 16. The hybrid ODS model associates the operational features with maintenance features, which represent the actual physical condition of specific engine components. MA module 15 then determines a confidence level for an overall correlation between real-time engine function (normalized features) and actual engine conditions (maintenance features), and generates maintenance requests as a function of the confidence level.

Operator/maintenance (O/M) interface 17 comprises a real-time operator interface and a maintenance interface. In various embodiments the operator interface includes display devices such as video displays, gauges and warning indicators, and control devices such as power controls, or, in aviation applications, flight and navigational controls. In some embodiments, the operator/maintenance interface is incorporated into a power plant control system, or a cockpit display and flight navigation system.

The maintenance interface comprises a maintenance record or maintenance log. The maintenance interface is configured for real-time access, synchronously with gas turbine engine operation, and for off-line or asynchronous upload at periodic intervals. The maintenance interface also includes a means for uploading actual maintenance actions performed on the engine to ODS 16, along with the corresponding physical condition of impacted engine components.

Uploading the maintenance record allows hybrid ODS 16 to make physical associations between specific maintenance features, such as component replacement or water wash, and specific operational features, such as blade features representing replaced or washed blades. The hybrid ODS also makes empirical associations, between, for example, maintenance features such as a borescope inspection, and blade trends that are empirically (or circumstantially) related to the maintenance feature, whether there is an obvious mathematical or physical basis for the association or not.

In operation of system 10, sensors 11 provide sensor signals to primary feature extraction (PFE) modules 12. Individual sensors variously transmit sensor signals to a single primary feature extraction (PFE) module, or to any number of PFE modules. Sensors 11 transmit the signals over sensor wires, a command and control bus, or, alternatively, via optical fibers, wireless optical or infrared devices, microwave devices, or other wireless devices.

Secondary feature extraction (SFE) modules 13 and higher-order feature extraction (HOFE) modules 14 extract secondary, tertiary, and higher-order features from PFE modules 12. HOFE modules 14, SFE modules 13, and PFE modules 12 perform digital communications among themselves, and with MA module 15. The digital communications are typically performed via digital data cables or a digital data bus, or, alternatively, via internal digital data pathways on integrated hardware devices. MA module 15, ODS 16, and O/M interface 17 communicate similarly.

In some embodiments, PFE, SFE, and HOFE modules 12, 13 and 14 communicate via a combination of digital and analog signals, in order to accommodate analog feature extraction based on analog integrators, analog computers, or related analog extraction functions. In further embodiments, any of PFE modules 12, SFE modules 13 or HOFE modules 14 communicate selected features directly to O/M interface 17. The selected features represent, for example, temperature, power level, fuel pressure, oil pressure, and other selected engine parameters. In aviation applications, additional selected features typically represent thrust, airspeed, altitude, attitude, and other engine parameters appropriate for a cockpit display. In these embodiments, PFE modules 12, SFE modules 13, and HOFE modules 14 communicate the selected features via any combination of digital and analog transmissions.

SFE modules 13 extract secondary features from PFE modules 12. The secondary features comprise derived features and trending features. Derived features are simply features that relate a number of different primary features; that is, they represent engine parameters such as thrust or power output, which are derived from a number of more fundamental physical parameters. In typical aviation applications, the derived features also represent engine parameters determined by an air data computer, including, but not limited to, airspeed, calibrated airspeed, equivalent airspeed, Mach speed (or Mach number), and altitude-related parameters.

Trending features (trends) are secondary features that represent rates of change, either in primary features or in other secondary features. In contrast to the prior art, system 10 does not limit trends to any particular absolute time scale, such as actual elapsed time, nor to any particular engine time scale, such as engine hours. Instead, system 10 utilizes a broad range of time scales for trending features, in which each time scale is locally defined according to the feature itself. SFE modules 12 also extract multiple trends from individual features, where the multiple trends represent not only different time scales (different units of time), but also different trending periods, including short-term, intermediate-term, and longer-term trending periods. In preferred embodiments, system 10 also incorporates changes in trends; that is, rates of change in trends, including generalized second-order time derivatives.

HOFE modules 14 extract higher-order features including tertiary, quaternary, and additional feature orders. In further contrast to the prior art, some higher-order features are increasingly physically descriptive, and other higher-order features are not necessarily more physically descriptive, but instead are more empirical. In particular, FOD/DOD assessment features incorporate both physically descriptive and empirical relationships, as applied to inlet and outlet debris features, blade features, trends, and other FOD/DOD indicators. Paralleling the hybrid ODS structure, moreover, FOD/DOD assessment features also incorporate both physical correlations, based upon mathematical or engineering models, and empirical correlations, based upon operating experience.

Thus FOD/DOD assessment features are not necessarily more physically descriptive than lower-order features, but are sometimes more empirical instead. FOD/DOD assessment features moreover incorporate a range of short-term, intermediate term, and long-term correlations, with each correlation window determined locally, by the trends themselves, rather than by any particular absolute or global time scale. This is a distinguishing element of system 10, and provides substantial advantages over the prior art. These advantages are illustrated by application to a particular gas turbine engine.

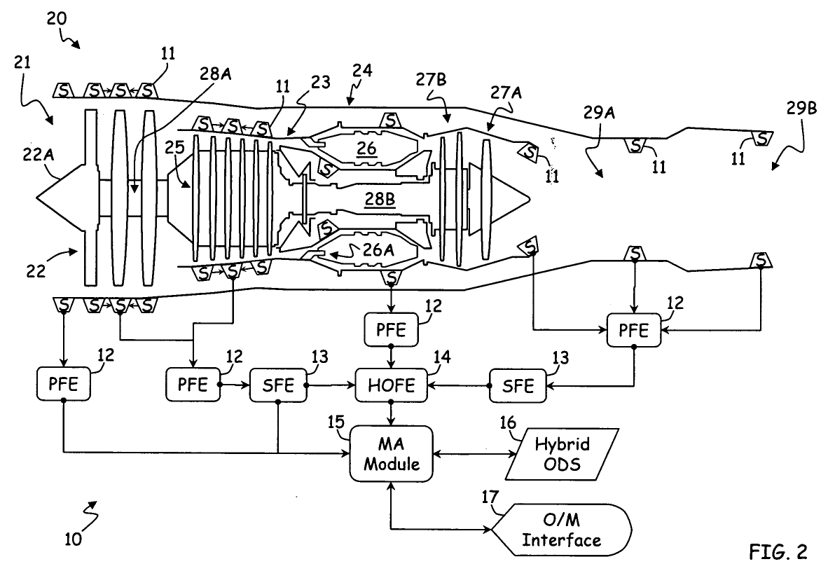

FIG. 2 is a schematic cross-sectional illustration showing FOD/DOD assessment system 10, configured for operation with gas turbine engine 20. System 10 comprises sensors 11, PFE modules 12, SFE modules 13, HOFE modules 14, MA module 15, ODS 16 and O/M interface 17, each as described above with respect to FIG. 1.

Gas turbine engine 20 comprises inlet 21, fan 22, inner engine housing 23, outer engine housing 24, compressor 25, combustor 26, turbine 27A and 27B, shaft assembly 28A and 28B, and nozzle assembly 29A and 29B. Typically, inner engine housing 23 comprises an inner engine casing or shroud, and outer engine housing 24 comprises a fan casing, which forms a bypass flow duct around the shroud.

In the particular embodiment of FIG. 2, gas turbine engine 20 is a low-bypass, twin-spool, afterburning turbofan engine. One example is an F-135 engine manufactured by Pratt & Whitney, a United Technologies Company headquartered in East Hartford, Conn. In this embodiment, turbofan engine 20 is configured for use in an F-35 Joint Strike Force (JSF) Lightning II aircraft. The illustrated engine is, however, merely exemplary. It is understood that FOD/DOD assessment system 10 is adaptable to a range of other engine configurations, including no-bypass, low-bypass and high-bypass gas turbine engines.

Outside air enters turbofan engine 20 via inlet 21. Fan 22 with spinner 22A is a three-stage fan performing the functions of a turbofan and a low-pressure compressor. Airflow downstream of fan 22 divides into a core flow within inner engine housing (shroud) 23, and a bypass flow in the duct between inner housing 23 and outer housing (fan casing) 24.

For the core flow, six-stage compressor 25 provides compressed air to annular combustor 26, entering via air/fuel inlets 26A. One-stage low-pressure turbine (LPT) 27A drives three-stage fan 22 via LPT shaft 28A, and two-stage high-pressure turbine (HPT) 27B drives compressor 25 via HPT shaft 28B. The nozzle assembly comprises afterburner 29A, in which thrust is augmented by the combustion of a fuel-air mixture upstream of exhaust 29B. The bypass flow bypasses compressor 25, combustor 26, LPT 27A and HPT 27B, rejoining the core flow proximate afterburner 29A.

The particular features of FIG. 2 are merely illustrative, and not all elements of a typical gas turbine engine are shown. For example, FIG. 2 shows only the rotor stages of compressor 25, LPT 27A and HPT 27B, and does not show the stator stages interspersed between the rotor stages.

Moreover, system 10 is not limited to the F-135 engine, nor to any of the particular engine components as illustrated by FIG. 2. Specifically, the F-135 is deployed in a fuselage-mounted configuration, in which outer engine housing 24 is surrounded by a fuselage and inlet 21 comprises a number of forward-mounted air intakes. System 10, however, is equally applicable to alternate wing-mounted or stabilizer-mounted configurations, in which outer engine housing 24 comprises a nacelle or cowling, and inlet 21 is a direct inlet.

In various embodiments, turbine engine 20 is further a low-bypass turbofan, as shown in FIG. 2, or a high-bypass turbofan, a medium-bypass turbofan, a turbojet engine, or a gas turbine engine configured to deliver rotational energy rather than reactive thrust. Engine 20 also has a variety of spool configurations, including single-spool configurations, twin-spool configurations (as shown in FIG. 2), and other multi-spool configurations.

FOD/DOD assessment system 10 is adaptable to each of these engine designs. In particular, sensors 11 are mountable proximate stator stages, forward-mounted air intakes, and other gas turbine engine components, whether or not they are shown in FIG. 2. Sensors 11 are also mountable proximate components external to gas turbine engine 20, such as a fuselage or flight control surface, or, alternatively, proximate electromechanical components of a power generation system.

Sensors 11 are positioned to characterize operational and functional parameters (engine parameters) related to gas turbine engine 20. Operational parameters include, but are not limited to, ambient pressure, ambient temperature, altitude, airspeed, Mach speed (Mach number), and control parameters such as vane or nozzle configurations, flap positions, rudder positions, and afterburner configurations. Functional parameters include, but are not limited to, gas path parameters, debris parameters, blade parameters, actuation parameters, lubrication parameters and mechanical parameters. Functional parameters also include sensor health parameters that characterize sensors 11, rather than gas turbine engine 20 itself.

Typical gas path parameters characterize spool speeds and state variables (pressure and temperature) for core or bypass flow proximate inlet 21, fan 22, compressor 25, combustor 26, turbines 27A and 27B, afterburner 29A, exhaust nozzle 29B, a bypass flow duct, or another engine station. Debris parameters characterize electrostatic charges proximate inlet 21 or exhaust nozzle 29B, or other debris signals at locations either internal or external to gas turbine engine 20. The blade parameters are characterized by blade sensors proximate fan 22, compressor 25, LPT 27A and HPT 27B, and include, but are not limited to, blade clearance and blade passing time. The actuation parameters characterize fuel pressure, fuel flow, bleed air valve position and other actuation variables. The lubrication parameters include, for example, oil pressure, oil temperature, and oil condition, and the mechanical parameters include vibrational amplitudes and frequencies proximate LPT shaft 28A, HPT shaft 28B, and other mechanical components.

Primary feature extraction (PFE) modules 12 extract primary (first-order) features that represent the engine parameters. Some primary features are direct indicators of FOD/DOD events. Other primary features are utilized to extract secondary and higher-order features, or are operational features utilized to normalize the functional features.

Direct FOD/DOD indicators include primary debris features representing ingestion proximate inlet 21, or ejection proximate exhaust nozzle 29B. Some primary blade features are also direct FOD/DOD indicators, including blade features that represent the loss or substantial distortion of a blade.

While primary features can indicate that engine damage has occurred, they are incapable of fully characterizing FOD/DOD events. Some debris features are associated with engine damage, for example, and others are not. More importantly, some debris features are not initially associated with detectable damage, but nonetheless trigger a damage propagation process that ultimately results in blade liberation or other significant FOD/DOD event.

Secondary feature extraction (SFE) modules 13 extract secondary (second-order) features representing derived features and trending features. Like primary features, some secondary features are also indicators of FOD/DOD events. Secondary features, however, tend to be indirect FOD/DOD indicators, rather than direct indicators. Other secondary features are used to extract higher-order features, or represent derived operational parameters used to normalize the functional features.

Indirectly indicative secondary features show the potential for engine damage, but are insufficient, alone, to discriminate between FOD/DOD events and non-events. In some cases, for example, a trend in a blade passing time feature at one engine operating regime indicates crack propagation due to a prior FOD/DOD event, and in other cases, in different engine operating regimes, the same trend indicates normal response.

Higher-order feature extraction (HOFE) modules 14 extract tertiary, quaternary, and additional feature orders from lower-order features (primary and secondary features), and from other higher-order features. Higher-order FOD/DOD assessment features are not limited to traditional trending, but incorporate more generalized correlations between features of different orders, including correlations between direct and indirect FOD/DOD indicators. FOD/DOD assessment features also utilize a multiform time scale, as defined locally by each individual feature, and correlate trends based on short-term, intermediate-term, and long-term correlation windows, as defined locally by each trend. MA module 15 tests these correlations by comparing normalized features (representing real-time engine function) to operational features in ODS 16 (representing the engine's operational history). ODS 16, in turn, associates the operational features with specific maintenance actions, utilizing a hybrid ODS model as described above.

The hybrid ODS model necessarily shares distinctive elements with the manifold feature structure. In particular, the hybrid model encompasses both physical and empirical associations. Physical associations are mathematical or engineering-based, and include well-understood causal relationships between particular FOD/DOD events and specific maintenance actions. Empirical associations need not be physical, but include circumstantial or experimental relationships that are not necessarily well understood from an engineering viewpoint.

These advantages of this generalized approach are illustrated by specific example. Consider an inlet debris feature extracted from a sensor proximate inlet 21, and an exhaust debris feature extracted from a sensor proximate exhaust 29B. These primary features are short-term, direct FOD/DOD indicators. A short-term correlation between inlet and exhaust debris features is a further direct indicator, as is known in the art.

Some inlet and exhaust debris features, however, are not actually associated with engine damage, even when correlated. Therefore system 10 also tests correlations between debris features and features defined by other time scales, such as trends in blade features. These correlations are not limited to the same short-term windows that characterize debris features, and the trends are not limited to the same “absolute” or elapsed time scale, but also utilize engine hours, engine rotations, and other locally-defined time scales.

As one example, some inlet and exhaust debris features are anti-correlated on a short-term elapsed time scale, but correlated on a longer time scale. The longer time scale is defined, for instance, by an intermediate trend in a blade passing time, as measured in engine rotations, or a long-term trend in another blade feature, as measured in engine hours. This example provides discriminatory power between non-events, associated with a harmless ingestions and normal wear and tear, and subtle FOD/DOD events, such as an initial nick or crack that later propagates to partial blade liberation.

Additional examples include debris features that correlate with short-term trends in blade features, such as adjacent blade spacing features. Again, this correlation provides greater FOD/DOD assessment power that either the trend or the debris feature alone. In particular, the correlation not only helps determine whether a specific maintenance action is necessary, but also helps direct that action toward a particular engine component, and avoids the much more time-consuming and costly alternative of full-scale disassembly and inspection.

Many FOD/DOD indicators are nonetheless subtle. While some features consistently correlate with particular maintenance actions, others correlate with much lower confidence. System 10, therefore, incorporates a range of different FOD/DOD features, and continually utilizes these established features to search for additional, even more generalized correlations, with even greater power to distinguish among different FOD/DOD scenarios.

FOD/DOD assessment features also encompass both forward-looking and backward-looking correlations, and utilize both continuous time scales (for example, to establish trending rates) and discrete time scales (to relate those rates to discrete debris features). In some correlations, moreover, the time scale collapses to a trivial state, in which the correlation becomes substantially spatial (that is, restricted to a particular engine station), rather than temporal (restricted to any particular order of events).

Operational data store (ODS) 16 also employs a similar generalized approach to associations between operational features and maintenance features. Debris features, for example, are typically associated with maintenance actions such as a visual fan inspection, a borescope inspection, or an engine teardown, and with the physical condition of the components involved. These associations have both physical and empirical aspects, in which, for example, a particular maintenance action appears to cause, rather than repair, engine damage, or in which non-physical sensor configurations are associated with sensor or controller failure, rather the physical condition of the gas turbine engine itself. Similarly, the hybrid ODS model associates blade trends with maintenance actions such as blade refurbishment or replacement on a number of different time scales, and utilizing a number of short-term, intermediate-term, and long-term correlation windows.

In general, physical associations and correlations should make sense from a mathematical or engineering standpoint. A trend (or change) in an engine compressor efficiency, for example, physically correlates with a water wash maintenance action (feature) undertaken to improve engine performance. Physical associations do not require actual correlation in each instance of operation, but actual correlations are relevant, because they help establish empirical guidelines such as preferred maintenance interval.

Empirical associations and correlations, on the other hand, require an actual correlation but do not require a mathematical or engineering model. One example is a particular trend in a blade vibration that through experience has demonstrated a pattern of correlation with crack propagation following an FOD/DOD event. This trend provides empirical evidence that a blade has suffered damage, whether there is an engineering model to explain the trend or not.

This approach allows system 10 to go beyond traditional trending and virtual sensor analysis to explore a much wider range of potential FOD/DOD scenarios. As a result, system 10 provides more specific maintenance requests with a lower false alarm rate, facilitating safer, more reliable, and more cost-effective gas turbine engine operations.

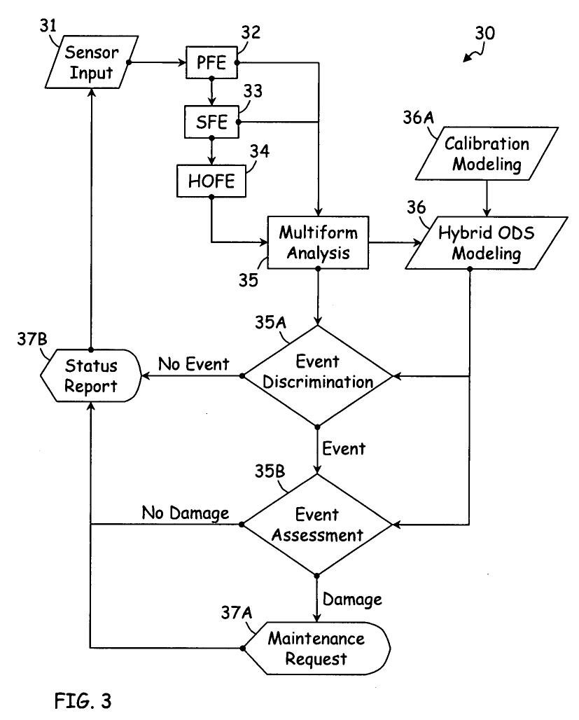

FIG. 3 is a flowchart illustrating method 30 for FOD/DOD assessment, utilizing manifold feature extraction and multiform analysis. Method 30 comprises sensor input (step 31), manifold feature extraction (steps 32-34), multiform analysis (step 35), modeling (steps 36 and 36A), discrimination (step 35A), assessment (step 35B), maintenance request (step 37A) and status report (step 37B).

Sensor input (step 31) comprises generation of sensor signals characterizing a multiplicity of engine parameters. The engine parameters comprise operational parameters such as altitude and airspeed, which relate to operating conditions of the gas turbine engine, and functional parameters such as gas path parameters and debris parameters, which relate to real-time engine function.

Manifold feature extraction is accomplished via primary feature extraction (PFE; step 32), secondary feature extraction (SFE; step 33), and higher-order feature extraction (HOFE; step 34), as discussed above. Generalized higher-order FOD/DOD assessment features utilize short-term, intermediate term, and longer-term windows to search for both forward-looking and backward-looking correlations. These correlations are determined according to multiform (locally defined) time scales, and represent both physical and empirical relationships.

Multiform analysis (step 35) comprises normalizing the manifold features as a function of the operational parameters, comparing the normalized features to the operational features, and generating maintenance requests as a function of the comparison. This is described in more detail with respect to steps 35A, 35B and 37A, below.

Modeling (step 36) comprises uploading operational features and maintenance features to generate an operational history of the gas turbine engine, and associating the operational features with the maintenance features via a hybrid ODS model. The operational features are normalized features, as uploaded from the multiform analysis (MA) module. The maintenance features are actual maintenance actions and associated physical engine conditions, as uploaded from a maintenance record or maintenance log. The hybrid ODS model employs both physical (mathematics or engineering-based) associations and empirical associations, corresponding to the manifold feature structure as described above.

In preferred embodiments, modeling also includes calibration (step 36A). In calibration, the ODS uploads operational and maintenance features that represent pre-operational test runs and other calibration tests performed during engine maintenance. Typically, calibration (step 36A) also comprises uploading additional operational and maintenance features representing an engine class to which the engine belongs.

FOD/DOD discrimination (step 35A) and assessment (step 35B) comprise comparing normalized features to corresponding operational features in the ODS, and determining a confidence level to describe an overall correlation between the normalized features (representing real-time engine function) and specific maintenance features (representing the physical condition of particular engine components).

Discrimination (step 35A) emphasizes discrimination between FOD/DOD events and non-events. The purpose of discrimination is to determine whether there has been a significant FOD/DOD event; that is, whether there is a likelihood that an engine component has suffered damage. FOD/DOD assessment (step 35B), on the other hand, determines the degree or amount of damage, if any, that has occurred. Both discrimination and assessment are based upon associations between specific operational features and particular maintenance features, as determined via the hybrid ODS model.

Maintenance request (step 37A) comprises generation of a maintenance request and transmission of the request to an operator/maintenance (O/M) interface. This step is performed as a function of the confidence level at which particular real-time engine functions (normalized features) are correlated with actual engine conditions (maintenance features). For low-confidence correlations, no maintenance request is generated. For high-confidence correlations, the maintenance request is recorded in a maintenance record or maintenance log. When significant engine damage is implicated, the maintenance request is also transmitted to a real-time operator interface, such as a cockpit display or control room console.

Status report (step 37B) comprises transmission of selected features to the O/M interface. The selected features typically characterize power output and other gas path parameters, as are typically displayed on a real-time operator interface. In aviation applications, the selected features also comprise altitude, airspeed, and other parameters, as are typically displayed on a cockpit display and flight navigation system.

Although the present invention has been described with reference to preferred embodiments, the terminology used is for the purposes of description, not limitation. Workers skilled in the art will recognize that changes may be made in form and detail without departing from the spirit and scope of the invention.

1. A foreign-object/domestic-object damage assessment system for a gas turbine engine, the system comprising:
a multiplicity of sensors for characterizing a multiplicity of engine parameters relating to the gas turbine engine;
manifold feature extraction modules for extracting manifold features from the multiplicity of engine parameters;
a multiform analysis module for performing a multiform analysis on the manifold features;
a hybrid operational data store for correlating the manifold features with maintenance actions; and
an operator/maintenance interface for transmitting maintenance requests as a function of the multiform analysis, as compared to the hybrid operational data store.

2. The system of claim 1, wherein the multiplicity of sensors comprises at least one of an inlet debris sensor and an exhaust debris sensor.

3. The system of claim 1, wherein the multiplicity of sensors comprises a blade sensor.

4. The system of claim 1, wherein the multiplicity of sensors comprises a vibrational sensor.

5. The system of claim 1, wherein the multiplicity of sensors comprises at least one of an altimeter, an airspeed sensor, an ambient air pressure sensor, or an ambient temperature sensor.

6. The system of claim 1, wherein the multiplicity of sensors comprises an engine gas path sensor.

7. The system of claim 1, wherein the manifold feature extraction modules extract a blade feature representative of at least one of a blade passing time, a blade clearance, or a blade vibration.

8. The system of claim 7, wherein the manifold feature extraction modules further extract a trend feature representative of a trend in the blade feature.

9. The system of claim 8, wherein the manifold feature extraction modules further extract a debris feature representative of debris passing at least one of an inlet of the gas turbine engine or an outlet of the gas turbine engine.

10. The system of claim 9, wherein the multiform analysis module analyses a correlation between the debris feature and the trend feature.

11. The system of claim 10, wherein the operational data store correlates the correlation with a maintenance action.

12. A method for foreign-object and domestic-object damage assessment, the method comprising:
sensing a multiplicity of engine parameters correlated with a gas turbine engine;
extracting a plurality of manifold features from the engine parameters;
performing a multiform analysis on the manifold features; and
generating a maintenance request as a function of the multiform analysis, as compared to a hybrid engine model of the gas turbine engine.

13. The method of claim 12, wherein sensing the multiplicity of engine parameters comprises sensing at least one of an inlet debris signal or an exhaust debris signal, and at least one of a blade passing time, a blade clearance, or a blade vibration.

14. The method of claim 12, wherein extracting the plurality of manifold features comprises extracting primary features representative of engine parameters, secondary features representative of trends in the primary features, and higher-order features representative of correlations among the primary and secondary features.

15. The method of claim 14, wherein performing the multiform analysis comprises analyzing a forward-looking correlation between a secondary feature and a later-in-time debris feature.

16. The method of claim 14, wherein performing the multiform analysis comprises analyzing a backward-looking correlation between a secondary feature and an earlier-in-time debris feature.

17. The method of claim 14, wherein performing the multiform analysis comprises analyzing an anti-correlation between a higher-order feature and a debris feature.

18. A foreign-object/domestic-object assessment system for a turbofan engine, the system comprising:
a multiplicity of sensors positioned proximate the turbofan engine;
feature extraction modules to extract manifold features from the multiplicity of sensors;
an analysis module to perform a multiform analysis on the manifold features;
a hybrid engine model to associate the manifold features with maintenance actions; and
a flight navigation system to control the turbofan engine and to transmit maintenance requests as a function of the multiform analysis, as compared to the hybrid engine model.

19. The system of claim 18, wherein the multiplicity of sensors comprises at least one of an inlet debris sensor or an exhaust debris sensor, at least one vibrational sensor, and at least one engine gas path sensor.

20. The system of claim 18, wherein the turbofan engine comprises a low-bypass afterburning turbofan engine configured for supersonic flight.
